(19) United States
(12) Patent Application Publication
(10) Pub. No.: US 2003/0156710 A1
(43) Pub. Date: Aug. 21, 2003

(54) Sound-transmitting apparatus

(76) Inventor: Stephen Kear, Preston (GB)

Correspondence Address: JENKINS & WILSON, PA, 3100 TOWER BLVD, SUITE 1400, DURHAM, NC, 27707, US

(21) Appl. No.: 10/258,469

(22) PCT Filed: Apr. 17, 2001
(86) PCT No.: PCT/GB01/01705

(30) Foreign Application Priority Data
Apr. 25, 2000 (GB) 0009980.4
Aug. 9, 2000 (GB) 0019418.3
Jan. 10, 2001 (GB) 0100704.6

(51) Int. Cl. H04M 1/00; H04M 9/00

(52) U.S. Cl. 379/388.01; 379/420.02

(57) ABSTRACT

Apparatus (10) for transmitting sound between a user and a communications device such as a mobile telephone comprises a non-electrical ear piece (13) connected via a tube (12) to an adaptor (22) which can be electrically connected to the mobile phone. A further tube (14) has a voice entry end (14b) and is coupled at the other end (14a) to the adaptor. Sound travels up tube (12) from the phone to the user and down tube (14) from the user to the phone.

The present invention relates to apparatus for transmitting sound from a sound generating element in or associated with a communications device to the ear(s) of a user of said communications device. The invention is particularly, though not exclusively, for use with a mobile telephone (also known as a ‘cell phone’). The term ‘sound’ as used herein is to be interpreted as a pressure wave of audible frequency.

Concerns about possible risks to human health from exposure to the radiation generated due to electrical activity in a mobile phone has led to the development of a separate ear piece connected to the mobile phone by electrical leads (the so called ‘hands free’ system). However, such an ear piece generates within it electrical activity and as this is, in use, located closer to the brain than even a standard hand-held telephone, the potential health risk is just as great, if not higher.

It is therefore an aim of embodiments of the present invention to provide sound-transmitting apparatus for use with a communications device, which addresses this problem.

It is a further aim of embodiments of the present invention to provide sound-transmitting apparatus which addresses the problems of conventional ways of transmitting sound from a communications device, whether referred to herein or otherwise.

It is a further aim of embodiments of the present invention to provide sound-transmitting apparatus for use with a standard ‘hands free’ kit supplied for use with a communications device such as a mobile phone.

According to an aspect of the present invention there is provided sound transmission apparatus for connection to a sound generating element in or associated with a communications device, the apparatus including at least one sound transmitting element arranged so as to transmit sound from the sound generating element to a user without generating electrical activity in or close to the user's ear(s).

The sound generating element may be, for example, a speaker located within the body of the communications device, or a separate sound generating element coupled electrically to the device.

Preferably, the apparatus includes means for transmitting sound from the user to the communications device.

Preferably, said sound transmitting element includes at least one conduit. Preferably, said conduit is a fluid-filled conduit and more preferably the fluid is air.

Preferably, the conduit has a first end adapted to be connected to a sound generating element in or associated with the communications device (for example a speaker in the device or an ear piece of a ‘hands free’ kit) so as to be in fluid communication therewith and a second end adapted to fit in or against an ear of the user whereby sound generated in the sound-generating element is transmitted by the fluid in the conduit to the or each ear of the user.

According to yet another aspect of the present invention there is provided apparatus for communicating sound emitted from a communications device to a user of that device, the apparatus including means adapted for connection to a sound generating element in or associated with the device and arranged so as to direct the generated sound non-electrically to the user.

Preferably, the conduit is a hollow flexible tube.

Preferably, the tube is made of plastics material.

Preferably, the second end comprises or has connected thereto an ear piece shaped so as to fit inside or slightly outside the user's ear.

Preferably, the ear piece is adapted so as to be suitable for use by people wearing hearing aids.

Preferably, the apparatus includes a microphone to enable the user to speak into the communications device as well as to listen to it.

Preferably, the microphone is positioned adjacent the sound generating element and a further conduit, for example a fluid-filled conduit, transmits sound from the user, via an open end of said further conduit, to the microphone to which its other end is connected.

Preferably said further conduit is also a hollow, flexible tube.

Preferably, said first-mentioned and further conduits are concentric. More preferably the conduit transmitting sound to the user is located inside the conduit transmitting sound from the user.

Alternatively, the microphone may be positioned on or adjacent the first-mentioned conduit, between its two ends, and is connected electrically to the communications device, or may be so connected.

Preferably, either or both of said conduits may be formed into a helical arrangement.

Preferably, said conduit(s) are provided in a variety of different colours.

Preferably, the communications device is a mobile telephone.

In one embodiment the sound generating element and/or the microphone are preferably provided with the apparatus and are adapted to be electrically connected to the communications device.

In another embodiment the sound generating element and/or the microphone are provided within the communications device which is provided with suitable connection means whereby the conduit(s) of the sound-transmitting apparatus may be connected to the communications device.

Preferably, the second end of the first mentioned conduit includes a clip shaped so as to fit around the outside of the user's earlobe. Such a clip may, for example, enable a person fitted with an in-ear hearing aid to use the apparatus by locating the ear piece of the apparatus just slightly outside the ear.

According to another aspect of the present invention there is provided a communications device incorporating apparatus according to any of the preceding paragraphs.

According to yet another aspect of the present invention there is provided a method of transmitting sound from a communications device to a user, the method including transmitting the sound along at least one sound transmitting element to an ear of a user, without generating electrical activity in or close to the user's ear(s).

Preferably, the method includes transmitting sound along at least one conduit.

Preferably, the method includes transmitting the sound by means of fluid within said conduit.

Preferably, the method includes connecting one end of said at least one conduit to a sound-generating element in or associated with the communications device.

Preferably, the method includes placing the other end of the conduit in or against the user's ear.

Thus, any electrical activity necessary to generate sound in response to an electrical signal may be located at a safe distance from the user's head, whilst still allowing sound to be transmitted between the device and the user. The invention is therefore a ‘hands free’ system (i.e. avoiding the need for the user to hold the device to the ear) but has no electrical activity in or close to the ear.

According to a yet another aspect of the present invention there is provided a hands free communication system in which the user listens to sound generated from a communications device or ear piece connected to said device through at least one sound-transmitting element.

For a better understanding of the invention, and to show how embodiments of the same may be carried into effect, reference will now be made, by way of example, to the accompanying diagrammatic drawings in which:

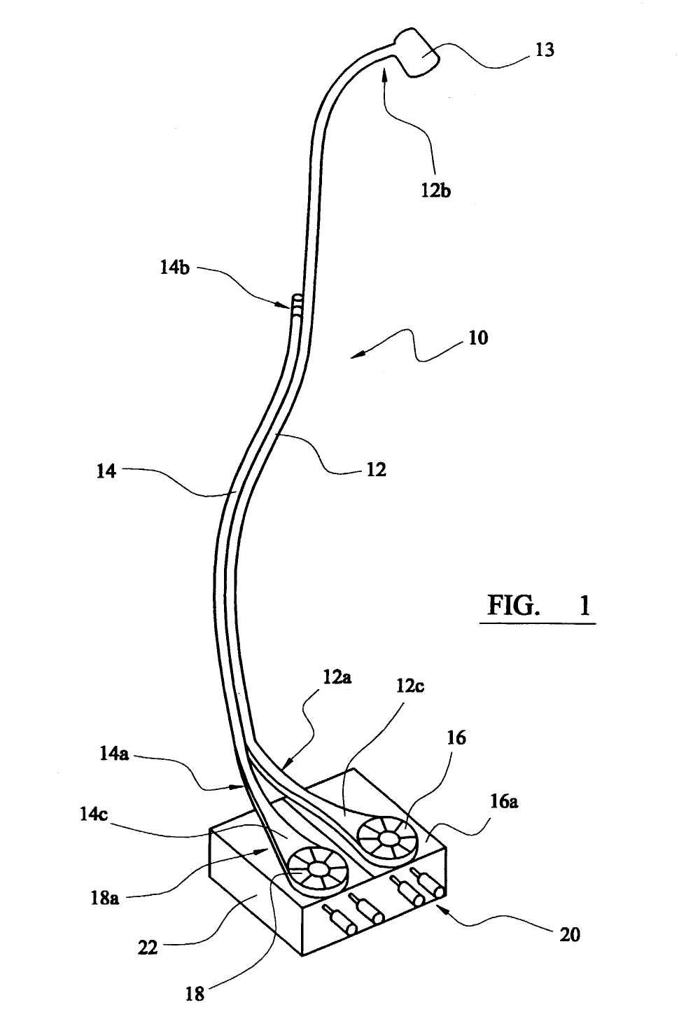

FIG. 1 illustrates schematically sound-transmitting apparatus according to a first embodiment of the present invention.

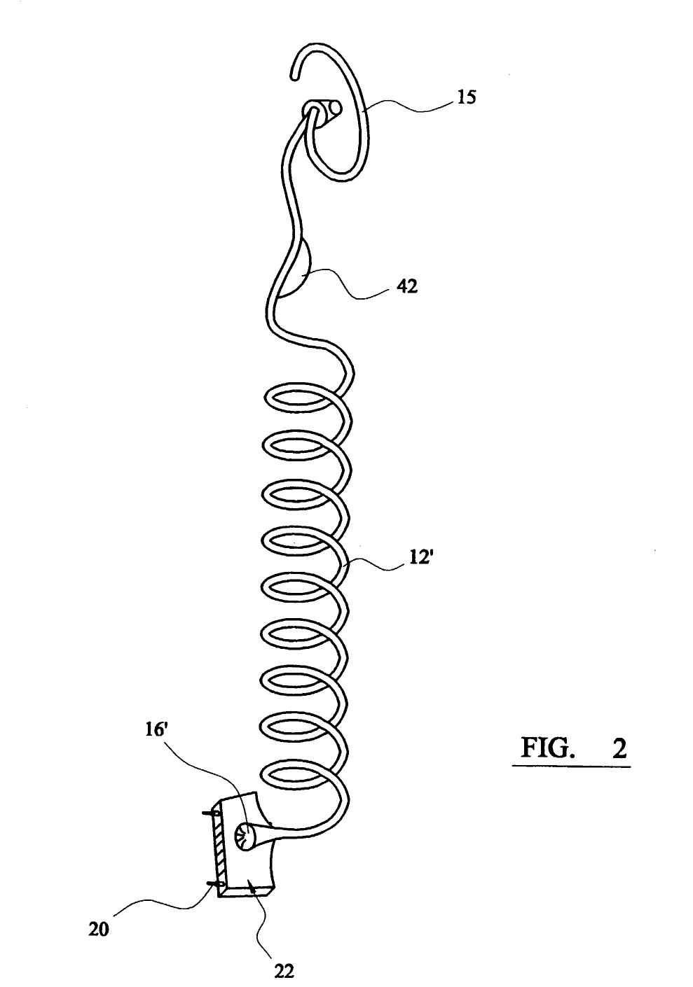

FIG. 2 illustrates a variant of the first embodiment.

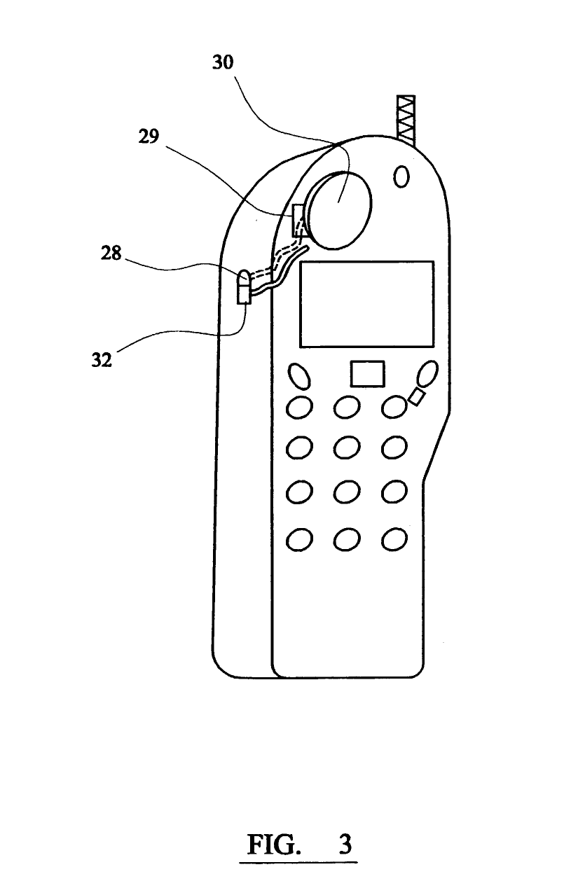

FIG. 3 illustrates a mobile telephone having connection means for apparatus according to the present invention.

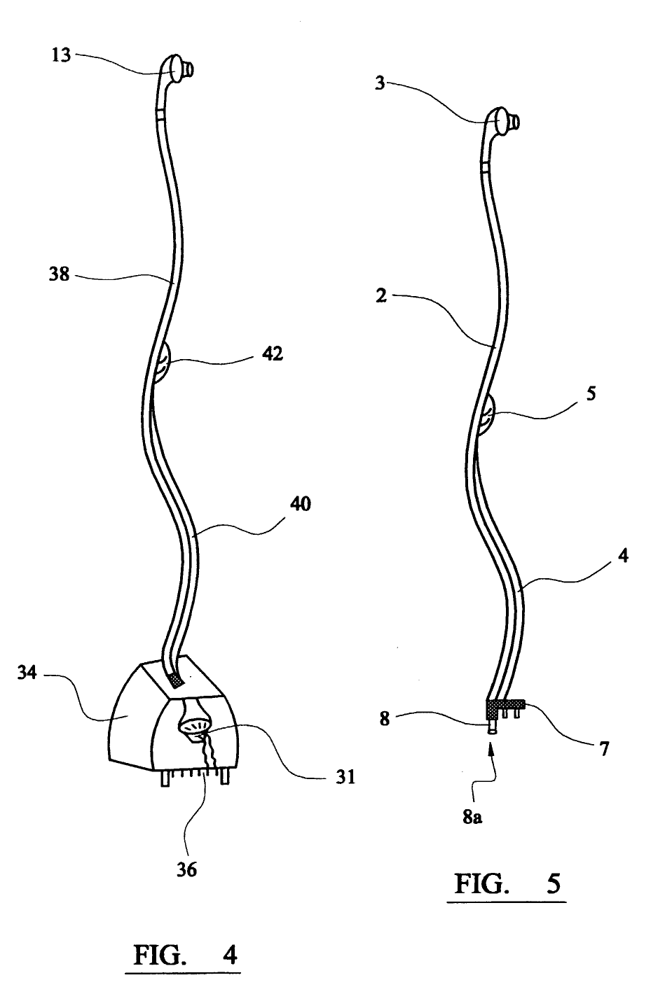

FIG. 4 illustrates a further embodiment of the invention.

FIG. 5 illustrates an embodiment suitable for connection to the mobile telephone of FIG. 3.

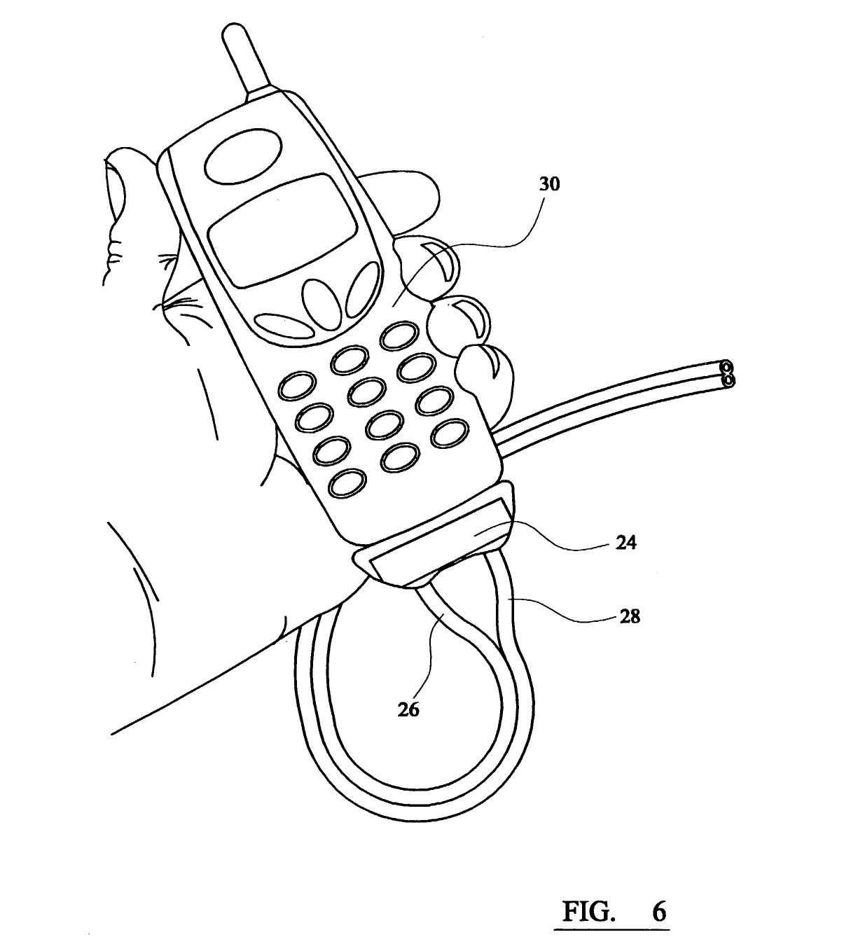

FIG. 6 illustrates one method of connecting the tubes to a mobile phone.

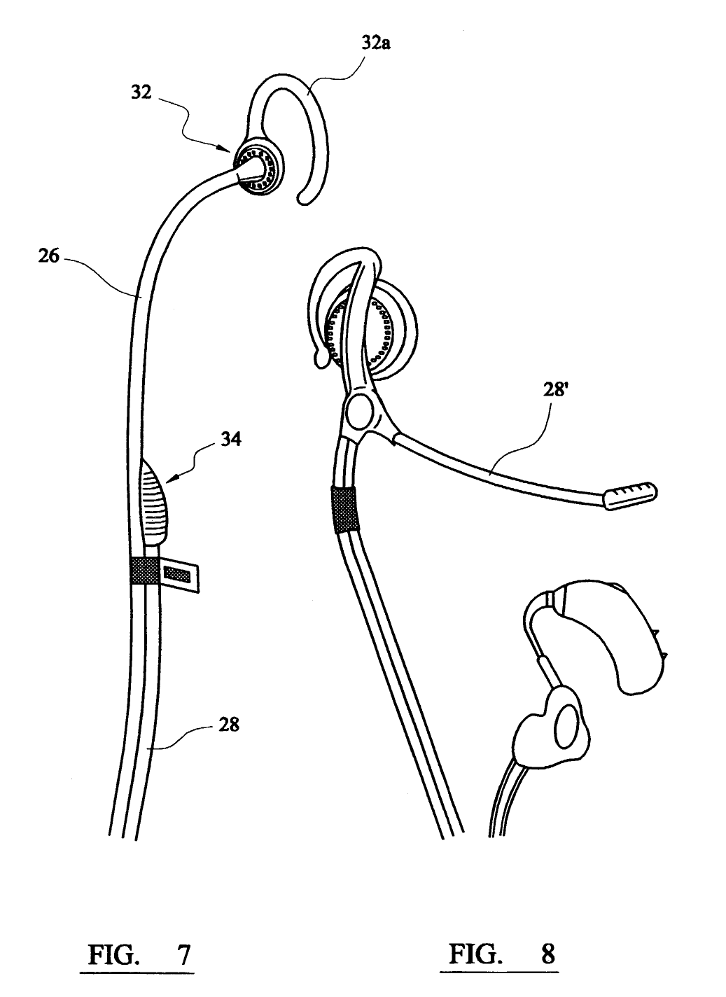

FIG. 7 illustrates one possible arrangement of earpiece and voice tube, using an extruded twin barrel tube.

FIG. 8 illustrates an alternative arrangement of ear piece and voice tube.

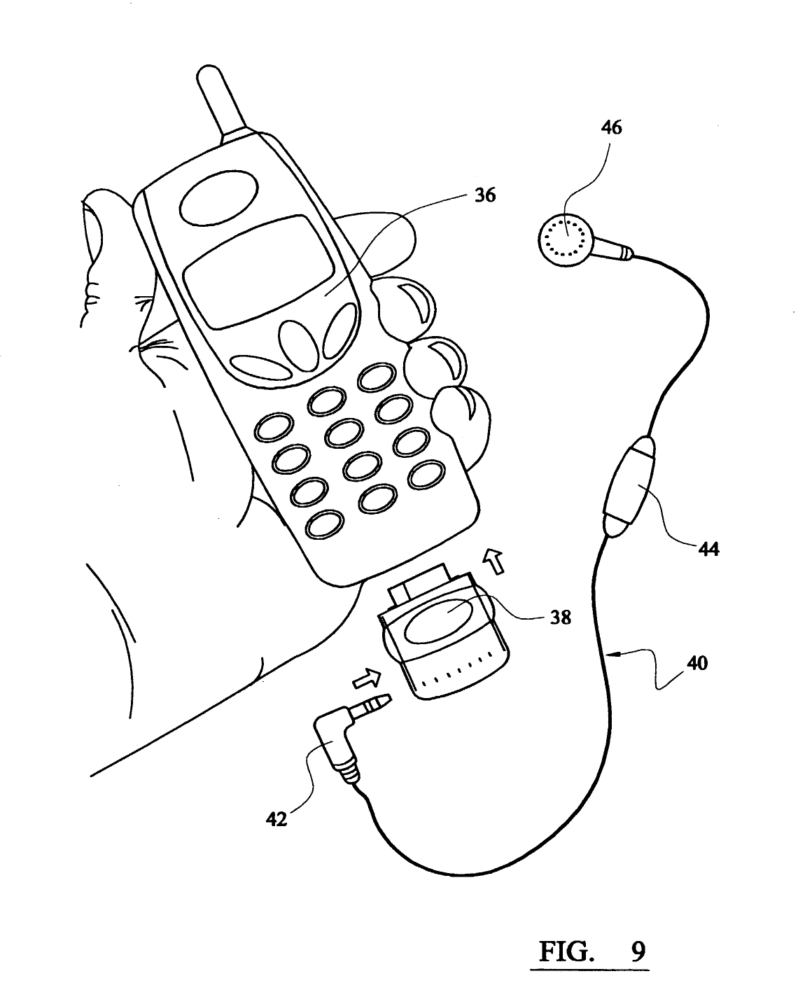

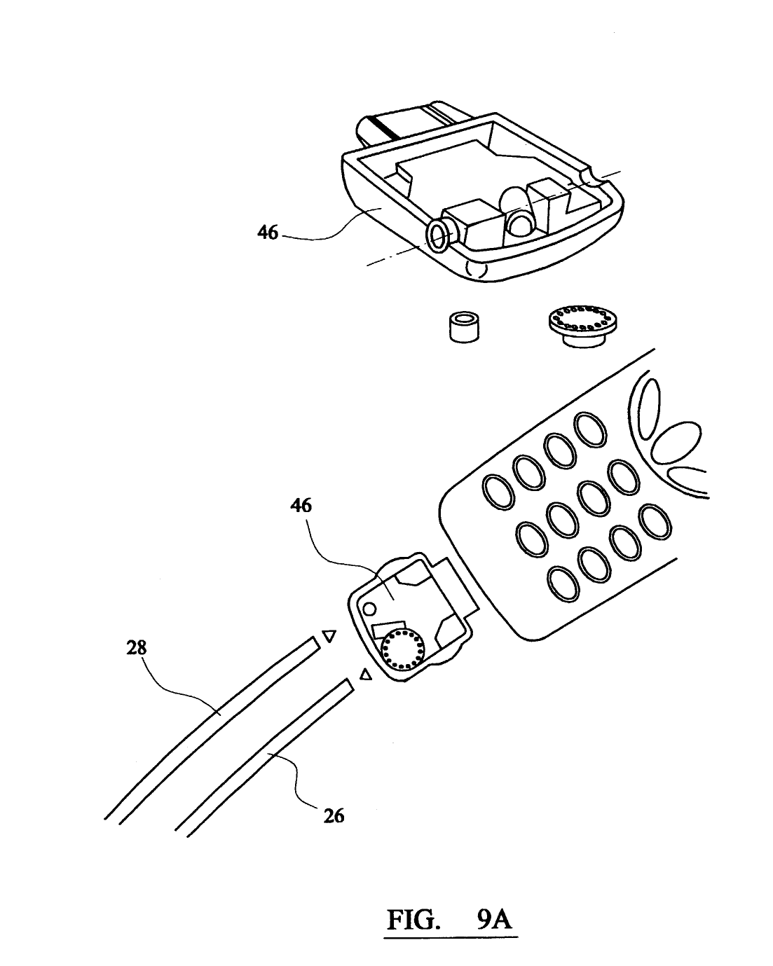

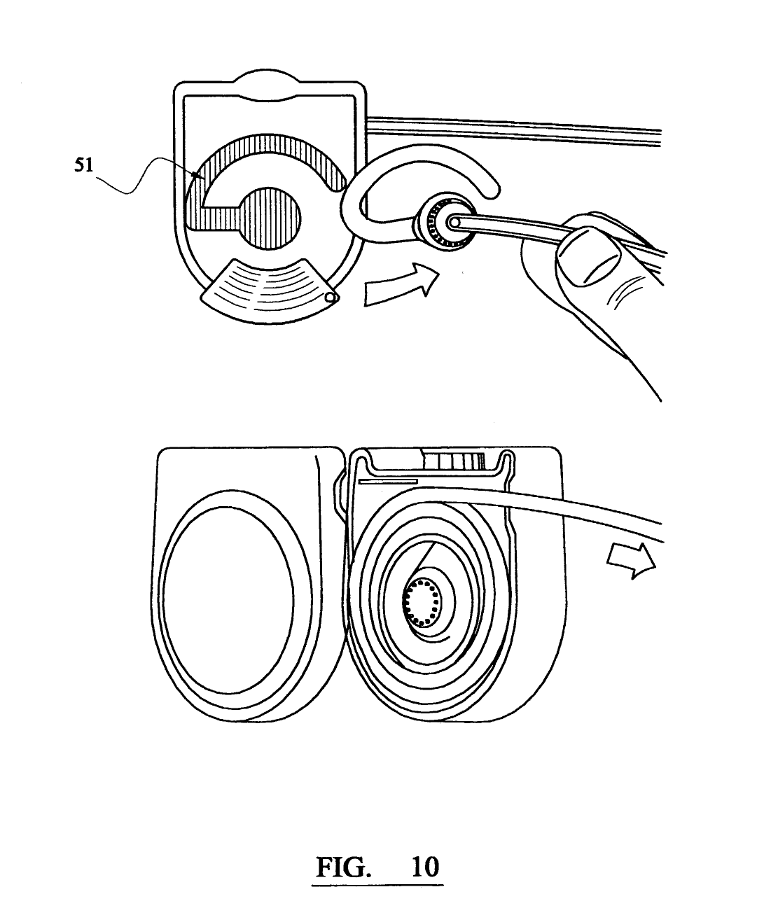

FIG. 9 illustrates a standard ‘hands free’ kit.

FIG. 9a illustrates how the tubes would fit into an existing adaptor.

FIG. 10 illustrates a modified adaptor including means for accommodating the tubes.

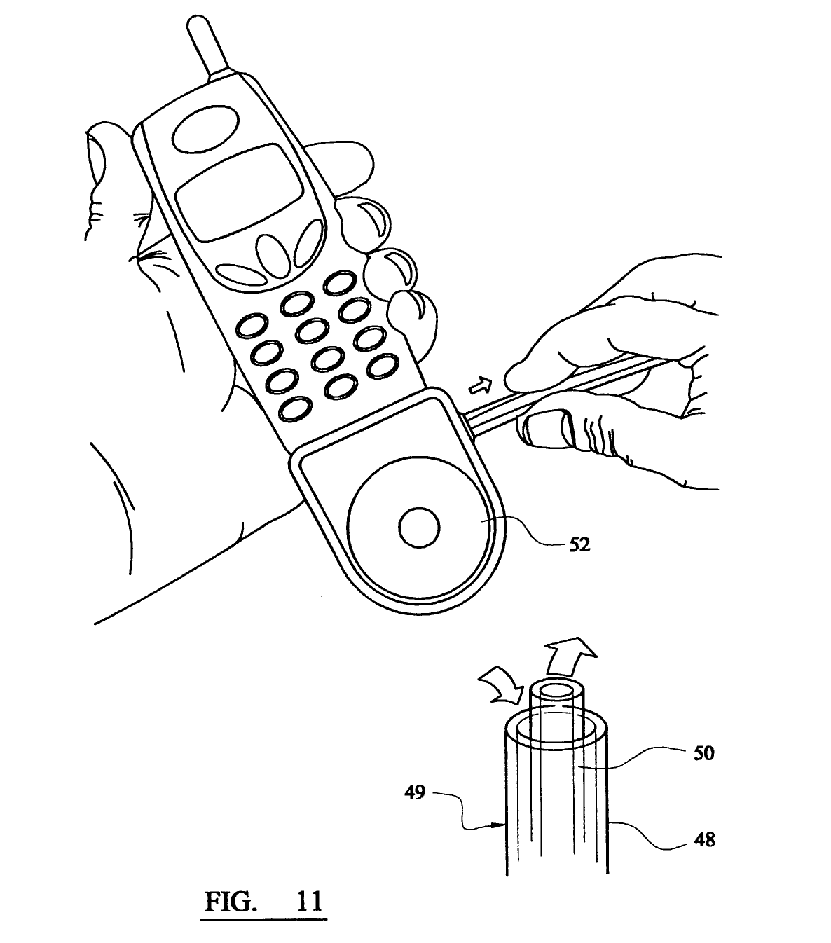

FIG. 11 illustrates use of the adaptor of FIG. 10.

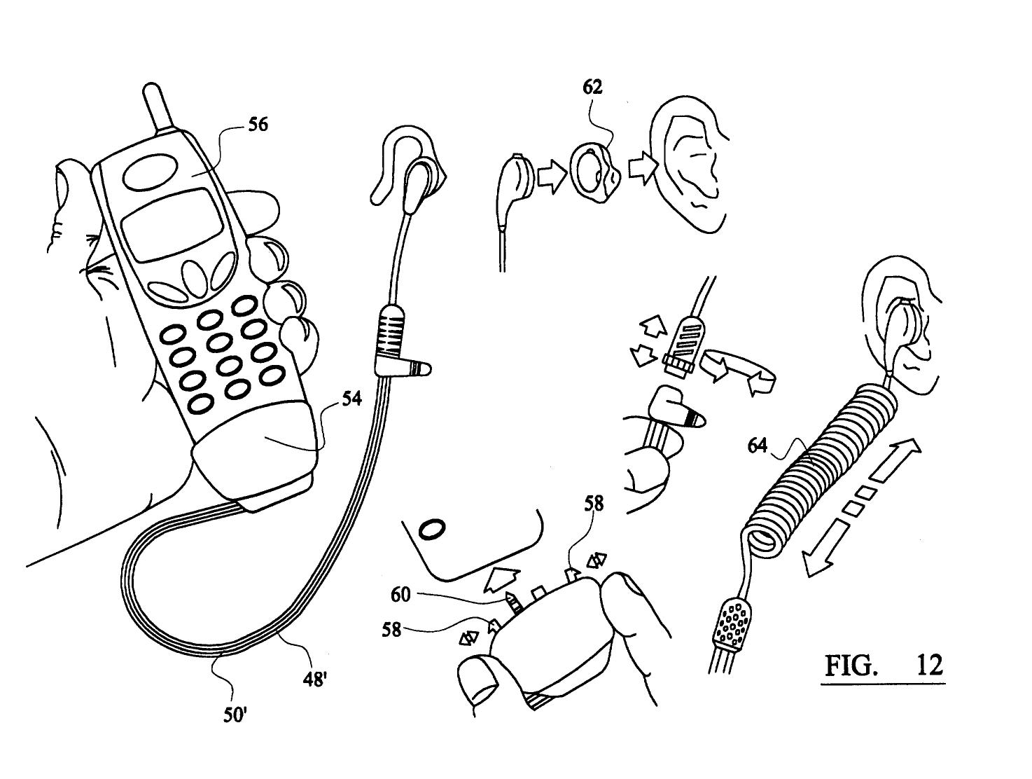

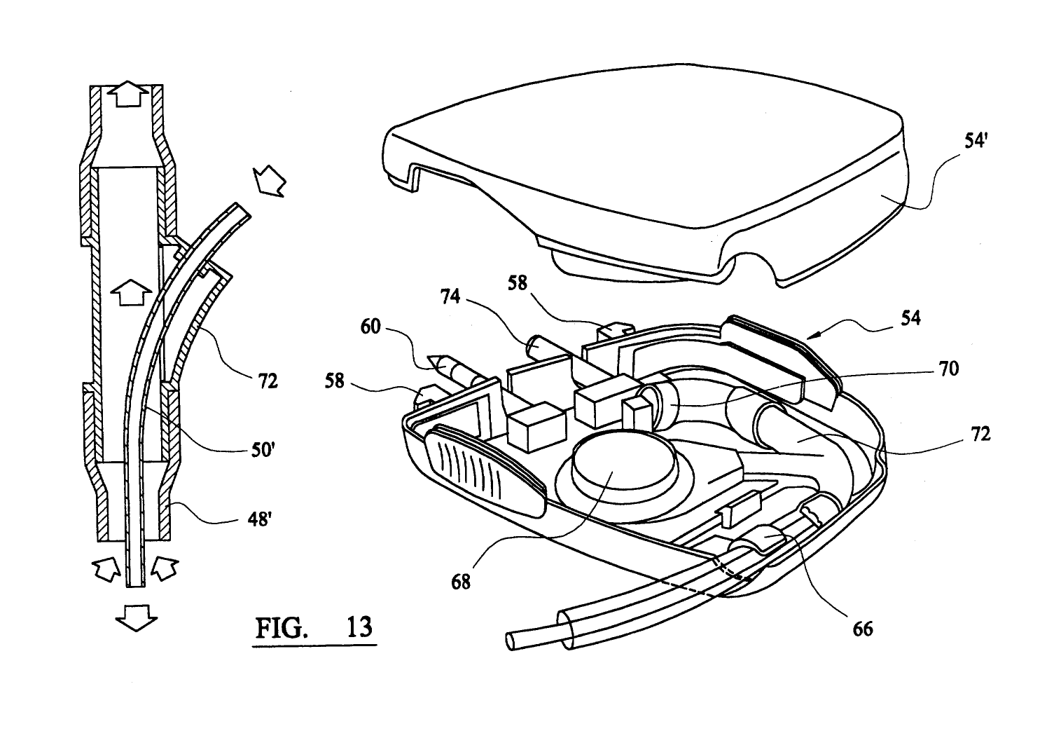

FIG. 12 is a general arrangement of the components.

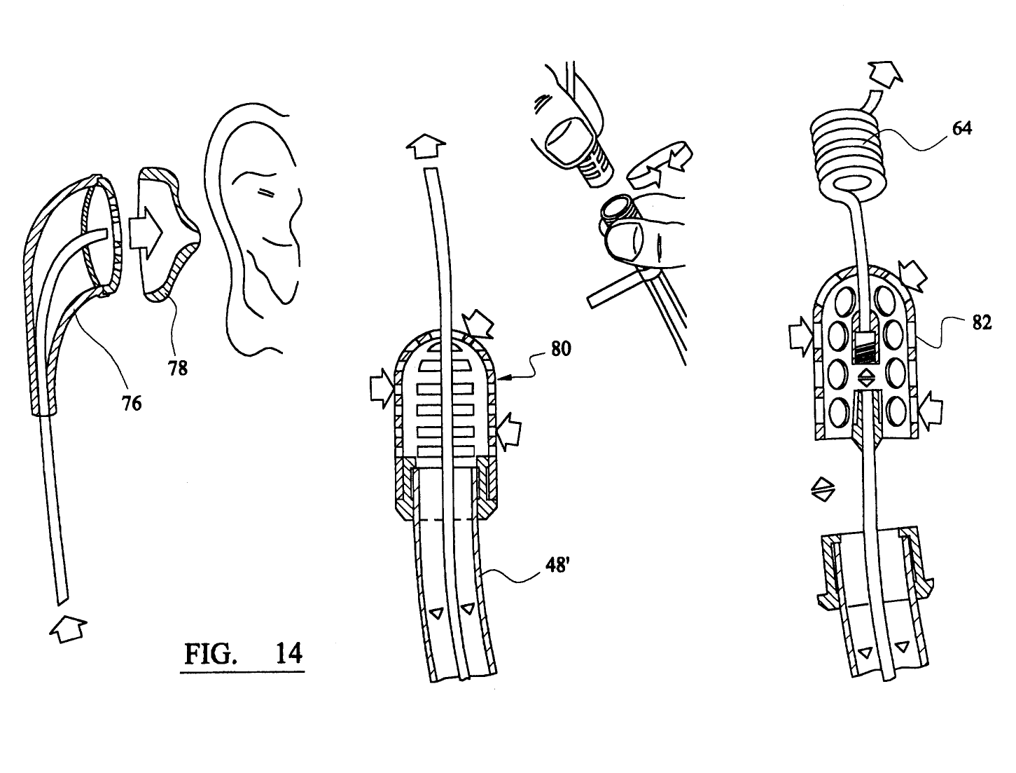

FIG. 13 is an exploded diagram of the adaptor unit.

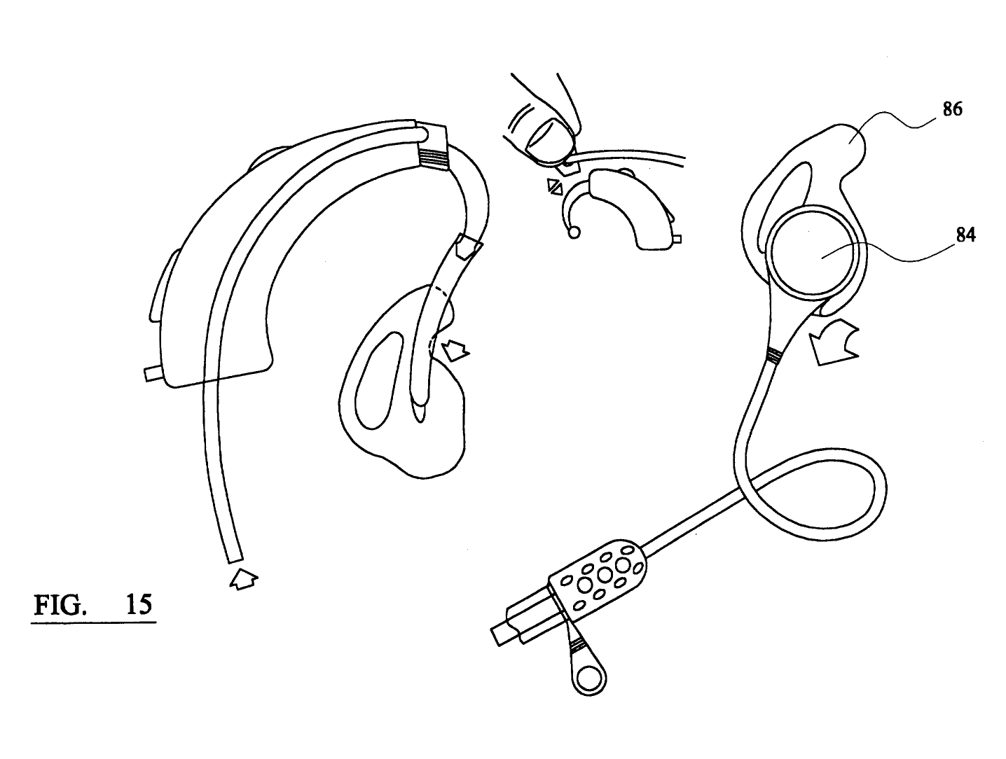

FIG. 14 illustrates the hearing and speech geometry.

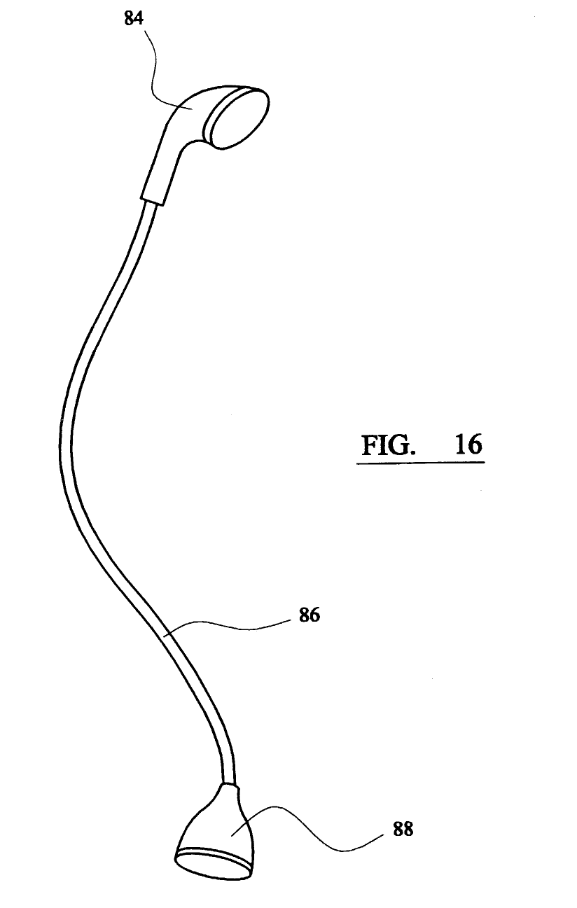

FIG. 15 illustrates an adaptation of the apparatus for use with a hearing aid.

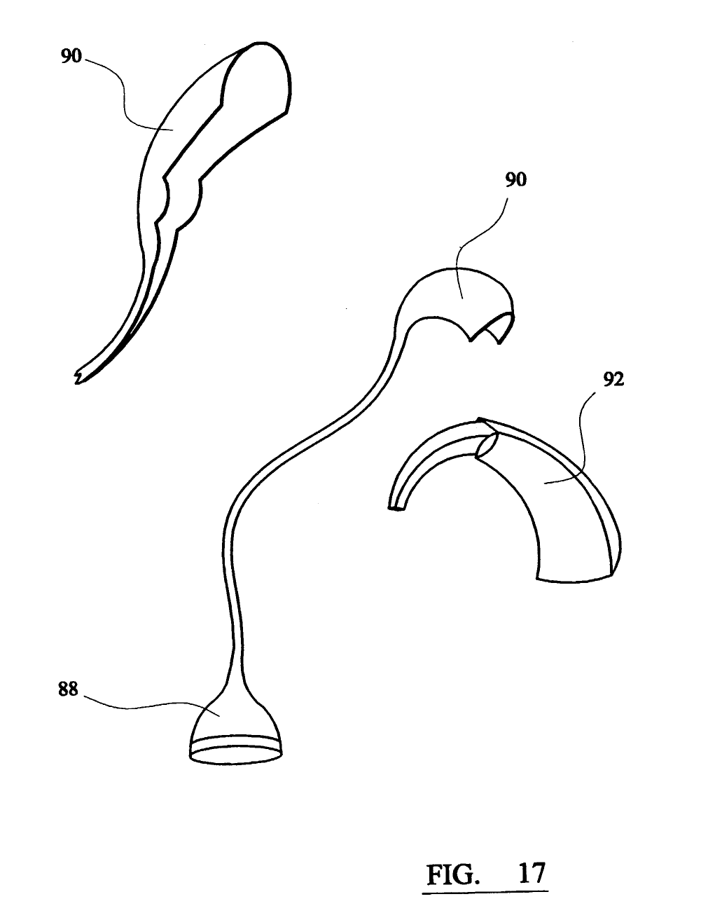

FIG. 16 illustrates an alternative embodiment for use with an earpiece on a standard hands free kit.

FIG. 17 illustrates an adaptation of the embodiment of FIG. 16, for use with a hearing aid.

Referring to the drawings and FIG. 1 in particular, a first embodiment of the present invention comprises apparatus 10 for transmitting said between a communications device (such as the mobile telephone of FIG. 3) and an ear of a user. The apparatus comprises a pair of hollow, flexible plastic tubes 12, 14 one of which (12) transmits sound from the mobile telephone to the user and the other of which (14) transmits sound from the user to the mobile telephone.

Both tubes are connected at their respective first ends 12a, 14a, via horn housings 12c, 14c, to a speaker 16 and a microphone 18 respectively. The speaker 16 is disposed in a speaker chamber 16a and the microphone is disposed in a microphone chamber 18a, respectively. Both chambers 16a, 18a are included within a plug body 22 which has electrical connectors 20 protruding therefrom.

The second end 14b of the tube 14 is open, terminating approximately two thirds of the way along the other tube 12 to which it may be attached. The second end 12b of the tube 12 terminates in an ear piece 13 shaped to fit in the user's ear.

In use, the plug body 22 is coupled to the base of a mobile telephone by means of electrical connectors 20, which send and receive electrical signals between the mobile telephone and the speaker 16 and microphone 18, respectively. The sound generated by speaker 16 is transmitted without any further electrical activity to the ear piece 13, by means of the fluid (e.g. air) inside tube 12. Sound spoken by the user is transmitted in similar fashion down tube 14 to microphone 18.

In FIG. 2, the tube 12′ for transmitting sound from speaker 16′ to ear piece 13 is formed into a helical spring shape, which permits a larger tube to be used without tangling. The second end is provided with a clip 15 shaped to fit around the ear, so as to help to retain ear piece 13 within the ear, or alternatively to locate the ear piece 13 just slightly outside the ear so that it may be used by a person wearing an in-ear hearing aid.

In FIG. 5, an alternative embodiment is illustrated in which there is only one tube 2, open at its first end 8 and incorporating an ear piece 3 at its other end. A microphone 5 is mounted on the tube 2 and is connected by a two-core wire 4 to a plug connector 7. Connector 8 is, in use, inserted into a socket 28 of the mobile telephone of FIG. 3, the socket 28 being in fluid communication with voice coil 30 via horn housing 29. Connector 7 is inserted into electrical socket 32 which is electrically connected to the telephone's transmitting device.

In FIG. 4, instead of terminating in simple connectors as in FIG. 5, a connector body 34 has electrical contacts 36 which plug into the base of a mobile telephone and connect voice coil 31 to the mobile telephone. The tube 38 is connected to the voice coil 31 and wire 40 from microphone 42 is connected to electrical contacts 36.

In FIG. 6 one embodiment is illustrated which uses a customised adaptor 24 to connect two tubes 26, 28 to the mobile phone 30.

As shown in FIG. 7, one of the tubes 26 is acoustically coupled at one end to the speaker and the other tube is coupled at one end to the microphone, using adaptor 24. At the other end tube 26 is fitted with a contoured non-electrical ear piece 32 which has a large acoustic chamber for tone range. A clip 32a helps to secure the ear piece against the ear. Tube 28 is fitted at its other end with a perforated tube head 34 which allows sound from the user to enter.

In FIG. 8 a variant is illustrated in which the voice tube 28′ is extended so that it is positioned in front of the user's mouth when the ear piece is inserted in the ear.

As shown in FIG. 9, a mobile phone 36 may be provided with a standard adaptor 38 for use with a hands-free kit comprising a connector 42 coupled via an electric lead to an electrically active earpiece 46 and a microphone 44. FIG. 9a illustrates the interior of an adaptor 46 similar to adaptor 38 which has been modified to accept the two tubes 26, 28.

FIGS. 10 and 11 illustrate an embodiment in which a concentric tube arrangement is used, the sound passing from the user to the device down outer tube 48 and from the device to the user up inner tube 50. The concentric tubes 49 are coiled in a retractable arrangement inside a specially designed housing 52 which also embodies the functional elements of the adaptor and may also include a recess 51 for the ear piece and ear piece clip. As shown in FIG. 11, the tubes 49 may simply be pulled out of housing 52 when required to be used and retracted back inside housing 52 when not in use.

FIG. 12 illustrates the general arrangement for components for a concentric tube system. An adaptor unit 54 is connected to a cell phone 56 by means of a clamping/locking device including a pair of snap-lock lugs 58. Jack plug 60 transfers the phone's ability to accept sound transmissions to the dedicated adaptor 54 in which a microphone and a speaker are placed so as to be attached to concentric tubes 48′, 50′. An amplifier may be provided on a small printed circuit board within the adaptor to boost the sound from the speaker, this amplifier being powered from the phone's power supply. In order to make the earpiece more comfortable, a silicon-type soft moulded ear plug 62 can be used. A separate, coiled tube 64 can be used from the ear piece to the speech entrance point, if required, to give extra freedom of movement.

FIG. 13 illustrates in more detail the inside of adaptor 54 and how the inner tube 50′ is taken out of outer tube 48′. The concentric tubes enter the adaptor at one side and are held in place by a tube retainer 66. The inner tube 50′ is then connected via coupling component 72 to the speaker which is covered with a hood 68 to direct and concentrate sound into the tube. The outer tube 48′ is connected directly to a microphone 70. A power input 74 from the phone is also shown. The adaptor 54 is closed by a casing 54′ which has a moulded-in acoustic wall to separate the microphone from the speaker.

FIG. 14 illustrates various aspects concerning the hearing and speech geometry. An acoustic baffle/reflector 76 may be used, in conjunction with a soft silicone-type moulded ear plug 78. Removal or replacement of the perforated speech entry head 80 from tube 48′ may be via a screw fit, push-on friction fit or snap-fit arrangement. FIG. 14 also illustrates an alternative speech entry head 82 suitable for use with a coiled tube attachment 64.

Referring now to FIG. 15, two alternative embodiments are proposed for use with hearing aids. In one arrangement, a limpet type attachment is placed over an existing ‘in-ear’ aid 86, thus taking the sound from the adaptor to the microphone in the ear plug unit and thereby eliminating the current problem of feedback sound encountered when trying to use a cell phone whilst wearing a hearing aid. Alternatively, an entire ‘behind the ear’ aid (such as an NHS or digital aid) could be incorporated within the adaptor and have a microprocessor incorporated onto a printed circuit board. Such an arrangement could amplify the sound and also be programmed via a computer to offer correct pitch, bass etc. whilst remaining compatible with a cell phone.

Referring now to FIG. 16, a simpler embodiment of the invention is illustrated which comprises a non-electrical ear piece 84 connected via a single, hollow tube 86 to a moulded silicone cover 88 which is shaped to fit over the ear piece of a conventional ‘hands-free’ kit 40. In such an arrangement, the conventional microphone 44 of the kit may be used.

As shown in FIG. 17, the ear piece 84 of FIG. 16 may be replaced by a silicone cover 90 which fits over the microphone area on hearing aid 92.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. Sound transmission apparatus for connection to a sound generating element in or associated with a communications device, the apparatus including at least one sound transmitting element arranged so as to transmit sound from the sound generating element to a user without generating electrical activity in or close to the user's ear(s).

2. Sound transmission apparatus according to claim 1 wherein the sound generating element is a speaker located within the body of the communications device, or a separate sound generating element coupled electrically to the device.

3. Sound transmission apparatus according to claim 1 or claim 2 wherein the apparatus includes means for transmitting sound from the user to the communications device.

4. Sound transmission apparatus according to any of the preceding claims wherein the sound transmitting element includes an air-filled conduit.

5. Sound transmission apparatus according to claim 4 wherein the conduit has a first end adapted to be connected to a sound generating element in or associated with the communications device so as to be in fluid communication therewith and a second end adapted to fit in or against an ear of the user whereby sound generated in the sound-generating element is transmitted by the fluid in the conduit to the or each ear of the user.

6. Apparatus according to any preceding claim, the apparatus including means adapted for connection to a sound generating element in or associated with the device and arranged so as to direct the generated sound non-electrically to the user.

7. Apparatus according to any of the preceding claims wherein the conduit is a hollow flexible tube.

8. Apparatus according to claim 7 wherein the tube is made of plastics material.

9. Apparatus according to any of claims 5 to 8 wherein is the second end comprises or has connected thereto an ear piece shaped so as to fit inside or slightly outside the user's ear.

10. Apparatus according to claim 9 wherein the ear piece 20 is adapted so as to be suitable for use by people wearing hearing aids.

11. Apparatus according to any of the preceding claims wherein the apparatus includes a microphone to enable the user to speak into the communications device as well as to listen to it.

12. Apparatus according to claim 11 wherein the microphone is positioned adjacent the sound generating element and a further conduit, transmits sound from the user, via an open end of said further conduit, to the microphone to which its other end is connected.

13. Apparatus according to claim 12 wherein said further conduit is a hollow, flexible tube.

14. Apparatus according to claim 12 or claim 13 wherein said first-mentioned and further conduits are concentric.

15. Apparatus according to claim 14 wherein the conduit transmitting sound to the user is located inside the conduit transmitting sound from the user.

16. Apparatus according to any of claims 11 to 15 wherein the microphone is positioned on or adjacent the first-mentioned conduit, between its two ends, and is connected electrically to the communications device, or may be so connected.

17. Apparatus according to any of claims 12 to 15 wherein either or both of said conduits may be formed into a helical arrangement.

18. Apparatus according to any of the preceding claims wherein the communications device is a mobile telephone.

19. Apparatus according to any of claims 5 to 18 wherein the second end of the first mentioned conduit includes a clip shaped so as to fit around the outside of the user's earlobe.

20. A communications device incorporating apparatus according to any of the preceding claims.

21. A method of transmitting sound from a communications device to a user, the method including transmitting the sound along at least one sound transmitting element to an ear of a user, without generating electrical activity in or close to the user's ear(s).

22. A method according to claim 21 and including transmitting sound along at least one conduit.

23. A method according to claim 22 and including transmitting sound by means of fluid within said conduit.

24. A method according to any of claims 21 to 23 and including connecting one end of said at least one conduit to a sound-generating element in or associated with the communications device.

25. A method according to claim 24 and including placing the other end of the conduit in or against the user's ear.

26. Sound transmitting apparatus or communications apparatus substantially as herein described with reference to-the accompanying drawings.

27. A method of transmitting sound from a communications device to a user, the method being substantially as herein described with reference to the accompanying drawings.
